(19) United States
(12) Patent Application Publication
(10) Pub. No.: US 2024/0052734 A1
(43) Pub. Date: Feb. 15, 2024

(54) MACHINE LEARNING FRAMEWORK FOR SWEEP EFFICIENCY QUANTIFICATION

(71) Applicant: SAUDI ARABIAN OIL COMPANY, Dhahran (SA)

(72) Inventors: Klemens Katterbauer, Dhahran (SA); Ibrahim Alobaidan, Dammam (SA); Marko Maucec, Englewood, CO (US); Alberto Marsala, Venezia (IT)

(73) Assignee: SAUDI ARABIAN OIL COMPANY, Dhahran (SA)

(21) Appl. No.: 17/818,888

(22) Filed: Aug. 10, 2022

(51) Int. Cl. E21B 43/16; E21B 47/0228

(52) U.S. Cl. CPC E21B 43/16; E21B 47/0228; E21B 2200/22; E21B 2200/20

(57) ABSTRACT

Methods and systems are provided for determining a sweep efficiency within a hydrocarbon reservoir. The method includes obtaining a well log for each of a plurality of wellbores penetrating the hydrocarbon reservoir, a deep sensing dataset for the hydrocarbon reservoir and determining a plurality of classified well logs, one from each well log using a first machine learning (ML) network. The method further includes determining a classified deep sensing dataset from the deep sensing dataset using a second ML network, training a third ML network to predict the sweep efficiency based, at least in part on the plurality of classified well logs and the classified deep sensing dataset at a location of each of the wellbores, and determining the sweep efficiency within the hydrocarbon reservoir using the trained third machine learning network based, at least in part, on the classified deep sensing dataset.

### BACKGROUND

The productive life of a hydrocarbon reservoir, such as oil or gas reservoirs, may be divided into three phases: primary, secondary, and tertiary. During the primary phase natural reservoir energy, such as gas drive, water drive or gravity drainage, displaces hydrocarbons from the reservoir, into the wellbore and up to surface. Initially, the reservoir pressure is considerably higher than the bottomhole pressure inside the wellbore. This high natural differential pressure drives hydrocarbons toward the well and up to surface. However, as the reservoir pressure declines because of production, so does the differential pressure. To reduce the bottomhole pressure or increase the differential pressure to increase hydrocarbon production, it is necessary to implement an artificial lift system, such as a rod pump, an electrical submersible pump or a gas-lift installation. Production using artificial lift is typically still considered primary recovery. The primary recovery stage reaches its limit either when the reservoir pressure is so low that the production rates are not economical, or when the proportions of gas or water in the production stream are too high. During primary recovery, only a small percentage of the initial hydrocarbons in place may be produced, typically around 10% for oil reservoirs.

The second phase of hydrocarbon production includes injecting an external fluid, such as water or gas, into the reservoir through injection wells located in rock that has fluid communication with production wells. The purpose of secondary recovery may be to maintain reservoir pressure and to displace hydrocarbons toward the wellbore. The most common secondary recovery techniques are gas injection and waterflooding. Normally, gas is injected into the gas cap and water is injected into the production zone to sweep oil from the reservoir. A pressure-maintenance program can begin during the primary recovery stage, but it is a form or enhanced recovery. The secondary recovery phase may reach its limit when the injected fluid (water or gas) is produced in considerable amounts from the production wells and the production is no longer economical. The successive use of primary recovery and secondary recovery in an oil reservoir produces about 15% to 40% of the original oil in place.

Traditionally, the tertiary phase of hydrocarbon production, include recovery methods that follow waterflooding or pressure maintenance. The principal tertiary recovery techniques used are thermal methods, gas injection and chemical flooding. The term is sometimes used as a synonym for enhanced oil recovery (EOR), but because EOR methods today may be applied at any stage of reservoir development, the term tertiary recovery is less commonly used than in the past.

In both the secondary and tertiary phases of production the injected fluid may be thought of as sweeping the remaining hydrocarbon ahead of an injected fluid front from the injection wells towards the producing wells. However, in practice the sweep efficiency of the sweep is never unity and some fraction of the original hydrocarbons always remain in the pores within the reservoir. Monitoring this sweep efficiency quantitatively may be desirable so that modifications to the parameters of injection may be made. For example, the rate of injection, the chemical composition, and the temperature of the injected fluid may be altered, or the wells from which the fluid is injected may be changed to enhance the sweep efficiency and improve the amount of hydrocarbon that would otherwise be recovered.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to methods for determining a sweep efficiency within a hydrocarbon reservoir. The method includes obtaining a well log for each of a plurality of wellbores penetrating the hydrocarbon reservoir, a deep sensing dataset for the hydrocarbon reservoir and determining a plurality of classified well logs, one from each well log using a first machine learning (ML) network. The method further includes determining a classified deep sensing dataset from the deep sensing dataset using a second ML network, training a third ML network to predict the sweep efficiency based, at least in part on the plurality of classified well logs and the classified deep sensing dataset at a location of each of the wellbores, and determining the sweep efficiency within the hydrocarbon reservoir using the trained third machine learning network based, at least in part, on the classified deep sensing dataset.

In general, in one aspect, embodiments relate to a non-transitory computer readable medium storing instructions executable by a computer processor, the instructions comprising functionality for receiving a well log for each of a plurality of wellbores penetrating a hydrocarbon reservoir, receiving a deep sensing dataset for the hydrocarbon reservoir, and determining a plurality of classified well logs, one from each well log using a first machine learning (ML) network. The instructions further include functionality for determining a classified deep sensing dataset from the deep sensing dataset using a second ML network, training a third ML network to predict the sweep efficiency based, at least in part on the plurality of classified well logs and the classified deep sensing dataset at a location of each of the wellbores. The instructions still further include determining the sweep efficiency within the hydrocarbon reservoir using the trained third machine learning network based, at least in part, on the classified deep sensing dataset.

In general, in one aspect, embodiments relate to a system including a fluid injection system and a computer system. The computer system may be configured to receive a well log for each of a plurality of wellbores penetrating a hydrocarbon reservoir, receive a deep sensing dataset for the hydrocarbon reservoir, and determine a plurality of classified well logs, one from each well log using a first machine learning (ML) network. The computer system is further configured to determine a classified deep sensing dataset from the deep sensing dataset using a second ML network, train a third ML network to predict a sweep efficiency based, at least in part on the plurality of classified well logs and the classified deep sensing dataset at a location of each of the wellbores. The computer system is further configured determine a sweep efficiency within the hydrocarbon reservoir using the trained third machine learning network based, at least in part, on the classified deep sensing dataset, and modify a sweep fluid injection program based, at least in part, upon the determined sweep efficiency. The fluid injection system may be configured to pump the modified sweep fluid injection program.

Other aspects and advantages of the claimed subject matter will be apparent from the following description and the appended claims.

### BRIEF DESCRIPTION OF DRAWINGS

FIG. 1 depicts a hydrocarbon reservoir undergoing secondary or tertiary recovery in accordance with one or more embodiments.

FIG. 2 depicts a seismic survey in accordance with one or more embodiments.

FIG. 3 depicts an electromagnetic survey in accordance with one or more embodiments.

FIG. 4 depicts well logs in accordance with one or more embodiments.

FIGS. 5A and 5B depict data distributions in accordance with one or more embodiments.

FIG. 6 depicts probability distribution functions in accordance with one or more embodiments.

FIG. 7 shows a neural network in accordance with one or more embodiments.

FIG. 8 shows a Long Short-Term Memory cell in accordance with one or more embodiments.

FIG. 9 shows a deep Long Short-Term Memory network in accordance with one or more embodiments.

FIG. 10 shows a workflow in accordance with one or more embodiments.

FIG. 11 depicts a flowchart in accordance with one or more embodiments.

FIG. 12 depicts an output in accordance with one or more embodiments.

FIG. 13 depicts a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

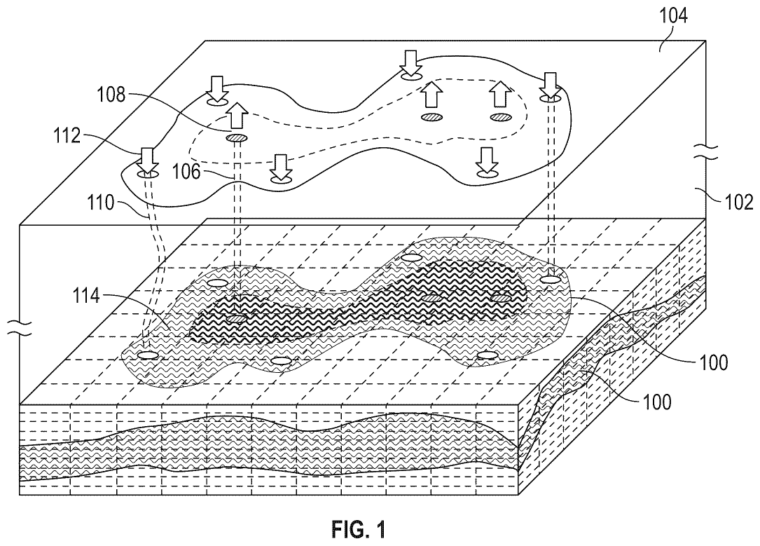

In the following description of FIGS. 1-13 any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “an injection well” includes reference to one or more of such injection well.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Methods and systems are disclosed describing method for estimating the sweep efficiency with which fluid injected into a hydrocarbon reservoir displace (“sweep”) hydrocarbons occupying the pores of the hydrocarbon reservoir toward production wells. The method combines data collected form wellbores, such as well logs and cores, with deep sensing data, such as electromagnetic, seismic, and gravity surveys, using machine learning (ML) networks to provide an estimate of the efficiency with the injected fluid has replaced the hydrocarbons and an estimate of the uncertainty of the estimated efficiency.

FIG. 1 depicts a perspective view of a hydrocarbon reservoir (100) undergoing secondary or tertiary recovery, in accordance with one or more embodiments. The hydrocarbon reservoir (100) may occupy a portion of a subterranean region of interest (102) lying below an area of the surface of the earth (104). The hydrocarbon reservoir (100) may be penetrated by a plurality of production wells, such as production well (106), that extend from a production wellhead (108) on the surface of the earth (104) to the hydrocarbon reservoir (100). Similarly, the hydrocarbon reservoir (100) may be penetrated by a plurality of injection wells, such as injection well (110), that extend from an injection wellhead (112) on the surface of the earth (104) to the hydrocarbon reservoir (100). Typically, in secondary and tertiary recovery fluid, such as water or a non-hydrocarbon gas, may be injected into the reservoir through the injection wells, e.g., injection well (110). Frequently, injection wells may be located around the periphery (114) of the hydrocarbon reservoir (100)

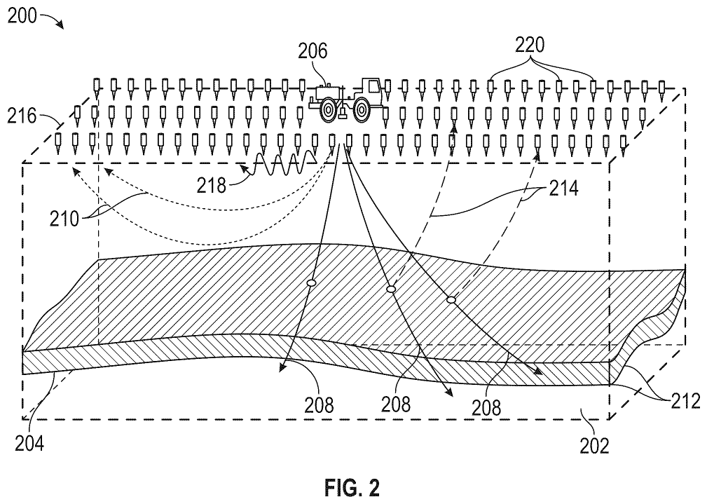

FIG. 2 shows a seismic survey (202) of a subterranean region of interest (102), which may contain a hydrocarbon reservoir (100). The seismic survey (202) may utilize a seismic source (206) that generates radiated seismic waves (208). In a land environment, the seismic source (206) may be a dynamite source or one or more seismic vibrators (“vibroseis truck”). In a marine or lacustrine environment, the seismic source (206) may be an air gun. The radiated seismic waves may be recorded by a plurality of seismic receivers (220). A single activation of the seismic source (206) may be recorded by tens or hundreds of thousands of seismic receivers (220). In a land environment, the seismic receiver (220) may record the velocity or acceleration of ground-motion. In a marine or lacustrine environment, the seismic receiver (220) may record pressure fluctuations caused by the radiated seismic waves (208).

The radiated seismic waves (208) may propagate along the ground surface as surface waves (“ground-roll”) (218), or the radiated seismic waves (208) may propagate below the surface and return as refracted seismic waves (210) or may be reflected one or more times by geological discontinuities (212) and return to the surface as reflected seismic waves (214).

The refracted seismic waves (210) and reflected seismic waves (214) generated by a single activation of the seismic source (206) are recorded by a seismic receiver (220) as a time-series representing the amplitude of ground-motion at a sequence of discrete times. This time-series may be denoted a seismic “trace”. A seismic source (206) is positioned at a location denoted (xₛ, yₛ) where x and y represent orthogonal axes on the surface of the Earth (104) above the subterranean region of interest (100). The seismic receivers (220) are positioned at a plurality of seismic receiver locations denoted (xᵣ, yᵣ). Thus, the refracted seismic waves (210) and reflected seismic waves (214) generated by a single activation of the seismic source (206) may be represented as a five-dimensional seismic dataset by (xₛ, yₛ xᵣ, yᵣ, t) where t delimits the time sample at which the amplitude of ground-motion was measured by a seismic receiver (220).

Seismic data recorded by a seismic survey (200) may be processed to produce a plurality of seismic images and/or seismic attributes in accordance with one or more embodiments. For examples, the seismic images may depict the topography of seismic wave reflectors (212) in the subsurface, including folds, anticlines, horsts, and faults that may form the structural boundaries hydrocarbon reservoirs. Similarly, seismic attributes may include reflection amplitudes, variation of reflection amplitudes with source-receiver separation or angle of incidence, and spectral characteristics of reflection amplitudes. Seismic attributes in particular may be particularly useful for indicating the type of fluid present in the pores of a subterranean rock and of the change in fluid type over a period of hydrocarbon production or of water or steam flooding.

The steps of converting raw seismic data into interpretable information about the subsurface is typically divided by workers of ordinary skill in the art into two separate categories. The first category often referred to as “seismic processing” converts raw seismic data into images, usually three-dimensional (3-D) images of the subsurface. These images are typically represented as grids or voxels with one or more value associated with each grid point or voxel. For example, the value may represent a reflection or scattering coefficient at that point in the subsurface, or a seismic wave propagation velocity value at that point.

Seismic processing typically includes subcategories such as pre-processing, noise attenuation, near-surface corrections, velocity analysis, imaging, and attribute generation. Pre-processing may include sorting (e.g., “demultiplexing”) and organizing the data (e.g., “common-midpoint sorting”) including integrating the seismic data with geometry and navigation data describing the locations of seismic sources and receivers at the time the seismic data was recorded. Further, pre-processing may include removing (“trace editing”) recordings from malfunctioning receivers, seismic wavelet estimation, correcting amplitudes for geometrical-spreading effects, and deconvolution (e.g., “predictive deconvolution”) to remove undesirable ringing caused by the recording system or the layered structure of the earth.

Seismic noise may include both coherent source-generated and random noise. For example, coherent source-generated may include ground- and mud-roll and both short- and long-period multiple reverberation from the earth. Random noise may include wind or ocean-swell induced noise, anthropogenic noise from nearby machinery (e.g., pumps) or traffic, and may include interference from seismic surveys being conducted in adjacent areas. Noise attenuation may include high-cut filtering of high-frequency noise, removal of surface waves (“ground-roll”) and other linear-propagating noise using frequency-wavenumber (e.g., “f-k” or “tau-p”) filtering, and multiple attenuation.

Near-surface corrections may include correcting for “ghosts” (e.g., “deghosting”) caused by the proximity of the surface of the earth or sea surface to the seismic sources and receivers, and for near-surface seismic wave propagation velocity and attenuation effects (e.g., “statics-correction”).

In order to determine the correct location of reflectors within the subsurface and generate images of geological structure and seismic attributes, it is necessary to determine the seismic wave propagation velocity at points (a “velocity model”) within the subsurface region of interest. A velocity model may be determined from in-situ measurements, i.e., in a wellbore and/or from the seismic data itself using a process called “velocity analysis”. Various velocity analysis methods are available each with their own computational cost and accuracy characteristics. Velocity analysis may include processes such as “normal-moveout estimation”, “tomography”, and “full waveform inversion” or, frequently, a combination of these methods, all of which are familiar to a person of ordinary skill in the art.

Once a velocity model has been determined, an image of seismic wave reflection or scattering may be determined using a method termed “migration.” As with velocity analysis, there are various methods of migration familiar to a person of ordinary skill in the art, each with its own computation cost and accuracy characteristics. For example, in order of increasing cost and accuracy, migration methods include Kirchhoff Time Migration, Kirchhoff Depth Migration, and Reverse-Time Migration. In each case a migration method aims to position a signal recorded by a seismic receiver at the location in the surface from which it was scattered or reflected.

Seismic processing may produce a number of 3-D images from the seismic data representing different “attributes” of the seismic data. For example, an image of the total amplitude of scattering at each point in the subsurface may be generated. Similarly, the amplitude of scattering within a restricted range of amplitudes may be calculated. Alternatively, the mean, median or mode of the spatial- or temporal-frequency of scattered seismic waves at each point may be imaged. In still other cases, the seismic propagation velocity or seismic propagation attenuation may be used as a seismic attribute.

Although described for convenience above as a linear sequence of steps, a person of ordinary skill in the art will understand that each step of the seismic processing chain is subject to review and quality control (QC) steps of an automatic, statistical, and/or manual nature. For this reason, among others, some seismic processing steps may be repeated immediately or at a later point in the sequence, to produce an improved, refined, or updated result. For example, the seismic velocity model may be updated after an initial migration has been performed. Alternatively, additional temporal-frequency filtering may be inserted into the sequence at numerous points.

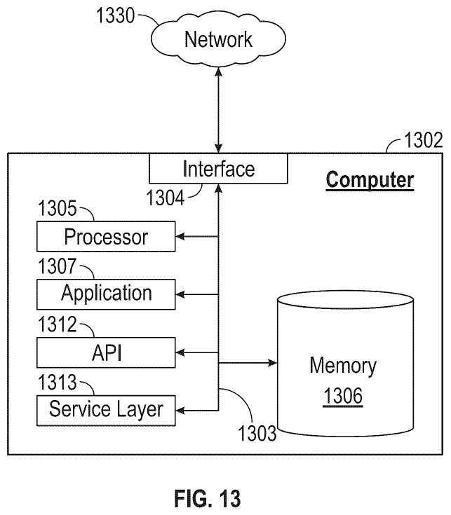

Seismic processing may be conducted using a computer system, such as the one shown in FIG. 13. A typical seismic survey dataset may easily be of the order of hundreds of terabytes in size, thus manual seismic processing is essentially impractical and processing a full seismic dataset may require substantial computer resources, including both computer processing and computer memory capabilities. In some embodiments, a seismic processing system may consist of computer hardware components that are specifically configured for the purpose of efficiently performing seismic processing steps. For example, a seismic processing system may typically include an array of computer-processing units (CPUs) with one or more subarrays of graphical processing units (GPUs) attached to each CPU. Tape readers or high-capacity hard-drives may be connected to the CPUs using wide-band data buses. In some cases, the seismic processing system may be co-located with the seismic analyst operating the system, while in other cases the seismic processing system may be implemented remotely from the seismic analysts, such as on “the cloud”, i.e., on computer hardware leased from a third-party at a remote location. In the latter case, the seismic analyst may perform command, control and QC on a local computer system and transmit instructions to and receive summary data from the seismic processing system over a network, including a secure network such as a virtual private network (VPN). A seismic analyst may interface with the seismic processing system on one or more computer monitors where visualization of the seismic data, the results of intermediate processing steps, and/or the final seismic image or attribute image may be displayed. These displays may include perspective visualization of 3D image cubes, planar vertical or horizontal slices, and non-planar surfaces (such as an undulating geological surface). In other cases, the seismic data may be displayed using virtual reality technology (e.g., goggles or “caves”) that allow the seismic analyst to “walk through” the seismic data).

The seismic dataset above is one type of deep sensing dataset. In accordance with one or more embodiments, other types of deep sensing datasets may be used in determining the sweep efficiency of a water, steam, gas, or other flood. For example, gravity datasets, active source resistivity datasets, passive (“magneto-telluric” dataset), or any combination of these datasets may be used.

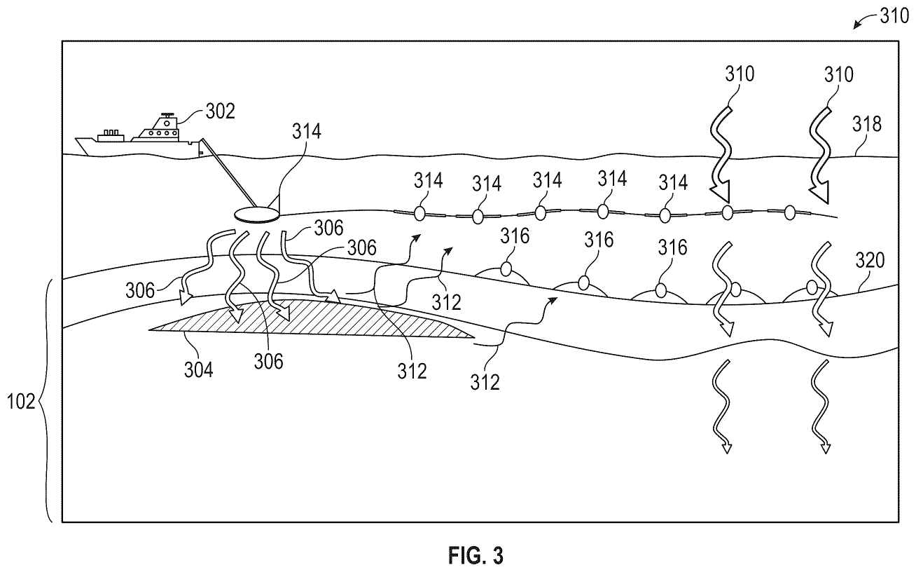

FIG. 3 illustrates an electromagnetic (EM) survey (300), in accordance with one or more embodiments. EM surveys, both airborne, ship (302) towed (as shown in FIG. 3) and ground deployed, are a commonly used deep sensing method in hydrocarbon exploration and monitoring. The technique may be proficient in direct detection of subterranean bodies (304) with conductive contrasts with the surrounding rocks, such as those that may exist between rocks containing water in their pores and those containing hydrocarbons including oil and gas. The EM survey (300) is based on response of the subterranean region (102) to the propagation of EM fields (306) composed of an alternating electric intensity and magnetizing force.

In accordance with one or more embodiments, a primary or inducing field may be generated by an active EM source (308), such as an active EM source (302) deployed from a ship (304). Such an active EM source (308) may pass an alternating current through a transmitter coil. In other embodiments, the natural variation with time of the Earth's magnetic and electric fields (310) may be used as a source. The magnetic component of an EM field (306) penetrating through the subterranean region of interest (102) may induce alternating currents (“eddy currents”) to flow with an ease dependent on the resistivity of the subterranean region (102). The eddy currents may generate their own secondary EM field (312) distorting the primary EM field (306).

The combined primary EM field (306) and secondary EM field (312) may be detected by a plurality of EM receivers, such as the EM receivers (314) and/or (316). In some embodiments, the EM receivers (314) may be towed, submerged beneath the sea surface (318) or in other embodiments EM receivers (316) may be disposed on the seabed (320). In still other embodiments, EM receivers may be deployed on dry land, in a wellbore or suspended from a aircraft, such as an airplane, helicopter, or drone.

An EM receiver at, or close, to the surface of the Earth, the ocean, or within a wellbore may respond to the combined of arriving primary EM field (306) and secondary EM field (312) so that the response differs in phase, amplitude, and direction from the response to the primary EM field (312). These differences between transmitted and received EM field reveal the presence of variations in resistivity in the subterranean region (102) and provide information on spatial variation of the resistivity.

By measuring at, or close to, ground level the time variations of the magnetic field and the electric components of the EM field, the ratio of the electric and magnetic variations provides a measure of the electrical resistivity of the subterranean region of interest (102). Depth information may be obtained by measuring the time variations over a range of frequencies. High frequencies penetrate the Earth only to shallow depths, while low frequencies penetrate to greater depths. Information may be obtained from a few hundred yards to hundreds of miles depth.

In accordance with one or more embodiments, a deep sensing survey may be conducted using gravimetry. The gravity field at the surface of the Earth depends on the mass density distribution of the subterranean region beneath the surface. For example, the values of the gravity field on the surface above an anomalously high-density portion of the subterranean region may be higher than the values of the gravity field above an anomalously low-density portion of the subterranean region. Gravimetry surveys measure the gravity field to a degree of precision. Gravimetry surveys may be sensitive to the contrast between dense fluids such as water, brine, or oil and light fluids such as gas present in the pores of the rock formations occupying the subterranean regions.

Deep sensing data may be acquired in time-lapse mode, in accordance with one or more embodiments. Time-lapse mode may require repeated deep sensing surveys conducted at times separated by a number of weeks, months, or years. Time-lapse deep sensing surveys may be particularly sensitive to temporal changes in the properties of the subterranean region over the period between the deep sensing surveys. For example, time-lapse deep sensing surveys may be particularly sensitive to the replacement of one pore fluid, such as oil, with another, such as gas, steam, or water, as the latter (gas, steam, or water) sweeps the former (oil) from regions near injection wells towards regions near production wells.

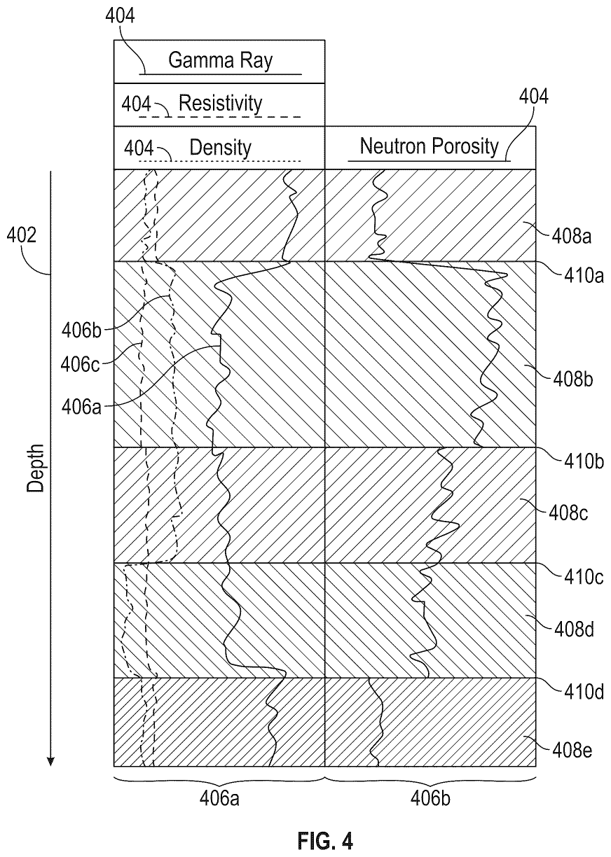

FIG. 4 depicts well logs (400) in accordance with one or more embodiments. A well log may be recorded by one or more well logging tools arranged in a well logging string and deployed in a wellbore penetrating a subterranean region of interest (102). The well logging string may be deployed in the wellbore using a wireline, or coiled tubing, or drillpipe and may be deployed after or during the drilling of the wellbore. Each well logging tool may record values of a physical parameter, such as gamma ray emission, resistivity, density, and nuclear magnetic resonance, of the rock penetrated by the wellbore at a plurality of depths within the wellbore.

Typically, the well log may be displayed as a function of depth (402) with the value of the physical parameter displayed on a horizontal axis (404). Values of multiple physical parameters (408a, b, c) may be plotted on the same chart (“track”) (406a) and/or on multiple tracks (406a, 406b). Well logs may be interpreted individually or in combination to identify various subsurface formations (408a-f) intersected by the wellbore and the subsurface boundaries (410a-d) separating the formations. For example, formations may be limestone, dolomite, sandstone, and shale. Additionally, well logs may be sensitive to the fluid filling the pores of the formation, allowing a person of ordinary skill in the art to identify a formation (e.g., a limestone) with water filling its pores from the same formation with oil filling its pores.

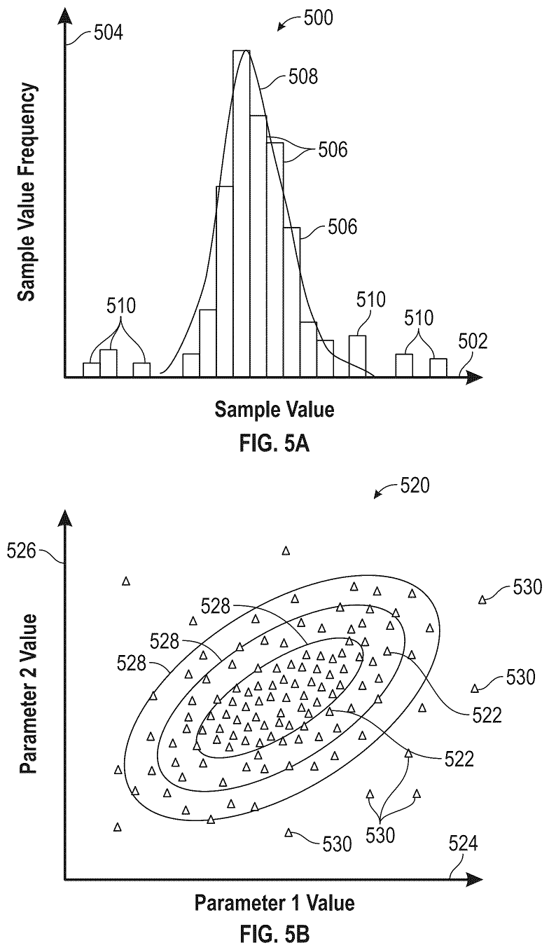

As with any physical measurements the values of well log samples may be erroneous or noisy and these errors and noise may be random or systematic. Systematic errors may be caused, for example, by mis calibrated sensors. In addition, any particular formation may have values of a physical value that vary over a range. For example, a limestone such as the Arab-D limestone may have a modal density value of 2.71 g/cc but a range that varies from 2.65 g/cc to 3.80 g/cc. Such a range of values may be characterized by a probability density distribution (500) as shown in FIG. 5A. The horizontal axis (502) indicates the value of the sample while the vertical axis (504) indicates the frequency with which each value occurs within a dataset. The vertical bars (506) indicate the samples making up an example dataset. Each vertical bar (506) represents a small range of sample values depicted by width of the vertical bar (506) and the number of sample values falling within that sample range indicated by the height of the vertical bar (506). In addition, FIG. 5A shows a theoretical or best-fit distribution (508) that may indicate the probability that a particular value may occur when a sample is drawn from the dataset.

FIG. 5A also shows certain sample values (510) lying outside the best-fit distribution (508). These values are often termed “outliers” and may be the result of erroneous measurements or noise. It is frequently desirable to exclude these outliers as being unreliable when determine the best-fit distributions. FIG. 5A depicts a single physical parameter, such as resistivity, but frequently multiple physical parameters, such as resistivity and density, may be considered together to determine which data points are outliers.

FIG. 5B depicts a two-parameter data distribution (520) in accordance with one or more embodiments. In FIG. 5B each sample has values of two physical parameters and is represented by a filled triangle, such as filled triangles (522). For each sample the value of physical parameter 1 (e.g., density) is indicated on the horizontal axis (524) and the value of physical parameter 2 (e.g., resistivity) is indicated on the vertical axis (526). The best-fit two-dimensional (2D) probability function may be depicted by contour lines (528) in this 2D example. In a manner analogous to the example shown in FIG. 5A, outlier samples such as outlier samples (530) may be identified lying outside the outer most contour or by other statistical means familiar to one of ordinary skill in the art.

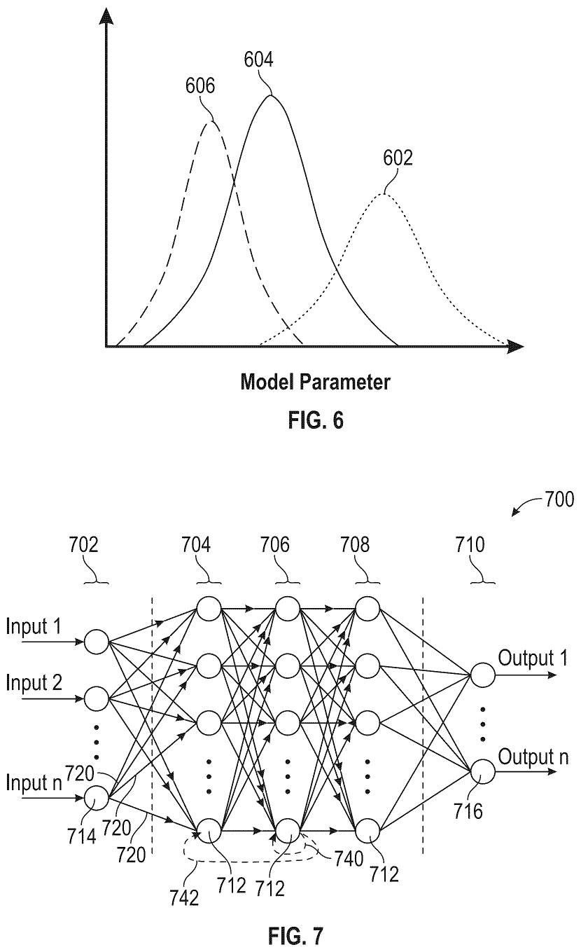

Probability distributions may be a convenient way of capturing both a parameter value and its uncertainty in accordance with one or more embodiments. Further Bayesian statistics may form a convenient framework for combining datasets of varying uncertainties to systematically track the uncertainty of the combined datasets. FIG. 6 depicts probability distribution functions (602, 604, 606) in accordance with one or more embodiments.

Processes such as forward modeling, inversion, and machine learning (ML) may be performed within the theoretical framework of Bayesian statistics, which is based on Bayes' theorem. In the context of this disclosure, Bayesian statistics defines a model parameter within a geophysical model as a degree of belief where Bayes' theorem quantifies the degree of belief using a probability distribution (PD). The PD may be continuous-valued, discrete-valued, or a combination of discrete and continuous. In accordance with one or more embodiments, the PD may be represented as a probability mass function (PMF) or a probability density function (PDF). Hereinafter, “degree of belief” and “PD” will be considered synonymous and used interchangeably. Bayes' theorem may be used to update a previous degree of belief as more evidence or information becomes available. By way of example, FIG. 6 depicts Bayes' theorem pictorially, in accordance with one or more embodiments. The previous degree of belief is referred to as a “prior” (602) denoted P(A). The prior P(A) (602) may be based on a prior assumption A or a previous “posterior”. A posterior (604), denoted P(A|B), is the degree of belief of A taking new evidence B into account. Bayes' theorem updates a prior P(A) (602) to a posterior P(A B) (604) based on the new evidence B such that:

$$P ( A \vert B ) = \frac{P ( B \vert A ) \cdot P ( A )}{P ( B )} , \qquad Equation ( 1 )$$

where P(B) is the degree of belief of the new evidence B or marginal and P(B|A) is a likelihood function (606). The law of total probability may be used to calculate P(B). P(B) may also be omitted, such as in cases where P(B) is difficult to calculate, such that:

P(A|B)∝P(B|A)·P(A) Equation (2).

The likelihood function P(B|A) (606) is a probability of B given A. In other words, the likelihood function P(B|A) (606) describes how likely the new evidence B is assuming A is true. The likelihood function, thus, shifts the degree of belief of A closer to the true or actual degree of belief of A.

Bayes' theorem may be used to update a PD of a model parameter within a geophysical model to shift the degree of belief of the model parameter closer to the true degree of belief iteratively. New evidence B is available for each iteration and the posterior P(A|B) (604) of the previous iteration k−1 becomes the prior P(A) (602) for the current iteration k such that:

P(Aₖ|Bₖ)∝P(Bₖ|Aₖ)·P(Aₖ₋₁|Bₖ₋₁) Equation (3).
This idea is known as Bayesian inference. Specifically, Bayesian inference is a method of statistical inference in which Bayes' theorem is used to update assumption A.

While Bayesian inference may be directly applied to update the PD of a model parameter, probability distribution sampling methods may also be implemented. One reason to implement probability distribution sampling methods is to reduce computational cost. One class of probability distribution sampling methods is the Markov chain Monte Carlo (MCMC) methods. In the context of this disclosure, MCMC methods may be used to generate sampled posteriors of model parameters. As the number of samples increases, the sampled posterior (604) approaches the true posterior determined by Bayes' theorem. MCMC methods generate sampled posteriors (604) by first constructing Markov chains. A Markov chain or Markov process is a stochastic model that describes a sequence of possible events where each transition from one event to another depends on a transition probability. One framework for constructing a Markov chain is the Metropolis-Hastings framework. Various algorithms that build upon the Metropolis-Hastings framework include, without limitation, Gi3s sampling, Metropolis-adjusted Langevin algorithm, Pseudo-marginal Metropolis-Hastings, and reversible-jump. Algorithms outside of the Metropolis-Hastings framework include, without limitation, slices sampling and Hamiltonian Monte Carlo. Once a Markov chain is constructed, a sampled posterior (604) is determined from the Markov chain by selecting random states of the chain using Monte Carlo sampling methods. Alternative to MCMC methods, variational inference methods may be used as probability distribution sampling methods. In brief, variational inference methods treat sampling the PD of a model parameter as an optimization problem of approximating the posterior (604).

Yet another model, which may be considered a ML model, is a stochastic process (SP). A SP is a collection of random variables (RVs). In general, a RV is a mathematical object. An RV may comprise a function, or a rule set, which maps an event to a numeric value. Different events, and therefore the associated numeric values, may be observed with different frequencies. As such, a RV often further comprises a PD representing the relative probabilities of observing an event. Depending on the properties and inter-relationships between the random variables, a stochastic process (SP) may be further defined. For example, if a finite collection of random variables may be jointly represented as a multi-variate Gaussian, the stochastic process (SP) is a Gaussian process (GP).

Each RV in a stochastic process (SP) is associated with a spatial location, temporal location, or both a spatial and temporal location. As such, a SP may be considered a collection of PDs, where each PD has a known location in space, time, or both space and time. To be concrete, consider a 1-dimensional spatial system with an “x-axis”. That is, a spatial location is specified with an x-value. Without loss of generality, x₁, x₂, x₃, . . . , xₙ may represent various locations along the x-axis. An SP may define a RV, and associated PD, at each location x₁, x₂, x₃, . . . , xₙ. The random variables (RVs) encompassed by a SP may be covariant.

One with ordinary skill in the art will appreciate that there are multiple ways to interpret and understand a stochastic process (SP). One such viewpoint is to consider a SP as defining a PD over a space of functions, often referred to as the “function-space view”. Like the Bayesian framework previously described, a stochastic process (SP) possesses the concept of a “prior”. In the Bayesian framework, the prior (602) indicates a degree of belief about an object A, such as a random variable (RV), which may be a model parameter. The Bayesian prior (602), as shown in FIG. 4, may be depicted as a PD. Because A has a PD, specific values of A may be “sampled” from the Bayesian prior (602). After observing data, or evidence, the Bayesian prior (602), could be “updated” through the application of Bayes' theorem in Equation (5) to form a new PD over A known as the posterior. Like the prior, the posterior could be used to sample specific values of A. The prior of a stochastic process (SP) defines a PD over the function space before observing any data or evidence. Once data, or evidence, has been observed, an SP is “conditioned” such that the PD over function space is congruent with the observed data. The conditioned, or updated, PD over function space could be considered a posterior. Because the posterior of a SP is a PD over a function space, sampling the PD returns a function. Functions sampled from the posterior of a SP will satisfy any constraints imposed by the observed data. In order to specify a PD over the function space, additional information must be provided to a stochastic process (SP). As an example, for a Gaussian process (GP), the PD over function space is specified with a “mean function” and a “kernel”. The mean function specifies the mean value of each random variable (RV) in the collection encompassed by the GP. Recall, that each RV in an SP, such as a GP, has an associated location—spatial, temporal, or both. As such, the mean function indicates the “expected” observed value at that location. Here, “expected” refers the expectation operator, where for a given continuous random variable X over a domain x with a probability density function p(x), the expectation is E[X]=∫_{-∞}^{+∞}xp(x).

The kernel of a Gaussian process (GP) indicates inter-relationships (i.e. covariances), if any, and their strength, between the RVs of the GP. GP kernels may be described by kernel functions. That is, a kernel function may accept any pair of RVs within the collection of the GP and return their covariance. As is often done in the literature, kernel functions may simply be referred to as kernels without undue ambiguity. Common GP kernels include, without limitation: white noise kernel; exponentiated quadratic kernel (also known as the squared exponential kernel, Gaussian kernel, or radial basis functions); rational quadratic kernel; and the periodic kernel. One with ordinary skill in the art will recognize that GP kernels may be formed specific to the context of the application, or GP kernels may be constructed from pre-defined kernels according to valid mathematical operations, such that those enumerated herein do not impose a limitation on the present disclosure. When a kernel function is used to determine covariances of a finite collection of random variables (RVs), the kernel may be considered a matrix. In order to be a valid GP kernel, the kernel matrix must be positive definite.

GP kernels often include hyperparameters such as a “length scale.” Additional hyperparameters may be associated with a GP. The combination of a selected GP kernel, a mean function, and any associated hyperparameters, define the PD over the function space. As such, the GP kernel, mean function, and hyperparameters, indicate the behavior of functions that may be sampled from the function space. For example, when using a periodic kernel, only periodic functions are sampled from the function space. Further, the hyperparameters of a periodic kernel may specify the expected period length, or frequency, of any sampled function.

Sampling methods may be applied to a geophysical dataset. Similar to applying probability distribution sampling methods to a geophysical model, one reason to implement sampling methods is to reduce computational cost. Sampling methods may include random sampling, active learning, and progressive sampling. With random sampling, every sample available for selection has the same probability of being selected and each sample selection is independent of any other sample selection. Alternatively, progressive learning is based on continuing to sample until accuracy stops improving. Alternatively still, the goal of active learning is to implement sample selection criteria to generate a subset of the dataset that maintains the diversity of the dataset and fully represents the dataset.

Uncertainty sampling and diversity sampling are two types of active learning that may be used individually or in combination. Uncertainty sampling targets confusing or unexpected samples in the dataset. Diversity sampling targets gaps in the dataset.

ML may be used to predict a sweep efficiency from a deep sensing dataset and/or a well log. ML, broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein, however, one skilled in the art will recognize that the concepts and methods detailed hereafter are not limited by this choice of nomenclature.

Machine-learned model types may include, but are not limited to, neural networks, random forests, generalized linear models, Bayesian methods, and stochastic processes (e.g. Gaussian process regression). Machine-learned model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. The selection of hyperparameters surrounding a model is referred to as selecting the model “architecture”. Generally, multiple model types and associated hyperparameters are tested and the model type and hyperparameters that yield the greatest predictive performance on a hold-out set of data is selected.

For example, FIG. 7 illustrates a neural network (700) in accordance with one or more embodiments. A neural network (700) uses a series of mathematical functions to make predictions based on observations. A neural network (700) may include an input layer (702), hidden layers, such as a first hidden layer (704), a second hidden layer (706), a third hidden layer (708), and an output layer (710). Each layer represents a vector where each element within each vector is represented by an artificial neuron, such as artificial neurons (712) (hereinafter also “neuron”). A neuron is loosely based on a biological neuron of the human brain. The input layer (702) may receive an observed data vector x where each neuron, such as neuron (714), within the input layer (702) receives one element xᵢ within x. Each element is a value that represents a datum that is observed. The vector x may be called “input data” and, in some embodiments, may be a preprocessed observed geophysical dataset. FIG. 7 displays the input data or vector x as elements x₁, x₂, xᵢ . . . xₙ, where x₁ may be a value that represents a well log sample at a first depth (406), and x₂ may represents a well log sample at a second depth (406), etc.

The output layer (710) may represent the vector y where each neuron, such as neuron (716), within the output layer (710) represents each element yⱼ within y. The vector y may be called “output data” and, in some embodiments, may be a geophysical model. FIG. 7 displays the output data or vector y with m elements, where an element yⱼ may be a value that represents resistivity at a spatial location within a subterranean region of interest (202). For example, y₁ and y₂ may represent density at a first spatial location and at a second spatial location, respectively, within the subterranean region of interest (202). In this embodiment, the neural network (700) may solve a regression problem where all outputs yₘ may depend on a temporal or spatial position.

Neurons in the input layer (702) may be connected to neurons in the first hidden layer (704) through connections, such as connections (720). A connection (720) may be analogous to a synapse of the human brain and may have a weight associated to it. The weights for all connections (720) between the input layer (702) and the first hidden layer (704) make up a first array of weights w, with elements wᵢₖ:

$$w = [ \begin{matrix}{w}_{11} & {w}_{12} & {w}_{1 k} & {w}_{1 L} \\ {w}_{21} & {w}_{22} & {w}_{2 k} & {w}_{2 L} \\ {w}_{i 1} & {w}_{i 2} & {w}_{i k} & {w}_{i L} \\ {w}_{n 1} & {w}_{n 2} & {w}_{n k} & {w}_{n L}\end{matrix} ] , \qquad Equation ( 4 ) ,$$

where k indicates a neuron in the hidden first hidden layer and L is the total number of neurons in the first hidden layer for the embodiment shown in FIG. 7. The elements in each column are the weights associated with the connections (720) between each of the n elements in vector x that propagate to the same neuron k (712) in the first hidden layer (704). The value of a neuron k, aₖ, in the first hidden layer may be computed as

aₖ=gₖ(bₖ−Σᵢxᵢwᵢₖ), Equation (5),
where, in addition to the elements of the input vector x and the first array of weights w, elements from a vector b, which has a length of L, and an activation function gₖ are referenced. The vector b represents a bias vector and its elements may be referred to as biases. In some implementations, the biases may be incorporated into the first array of weights such that Equation (5) may be written as aₖ=gₖ(Σᵢxᵢ wᵢₖ).

Each weight wᵢₖ within the first array of weights may amplify or reduce the significance of each element within vector x. Some activation functions may include the linear function g(x)=x, sigmoid function

$$g ( x ) = \frac{1}{1 + {e}^{- x}} ,$$

and rectified linear unit function g(x)=max(0, x), however, many additional functions are commonly employed. Every neuron in a neural network may have a different associated activation function. Often, as a shorthand, activation functions are described by the function gₖ by which it is composed. That is, an activation function composed of a linear function may simply be referred to as a linear activation function without undue ambiguity.

Similarly, the weights for all connections (720) between the first hidden layer (704) and the second hidden layer (706) make up a second array of weights. The second array of weights will have L rows, one for each neuron in the first hidden layer (704), and a number of columns equal to the number of neurons in the second hidden layer (706). Likewise, a second bias vector and second activation functions may be defined to relate the first hidden layer (704) to the second hidden layer (704). The values of the neurons for the second hidden layer (706) are likewise determined using Equation (5) as before, but with the second array of weights, second bias vector, and second activation functions. Similarly, values of the neurons for the third hidden layer (708) may be likewise determined using Equation (5) as before, but with the third array of weights, third bias vector, and third activation functions. This process of determining the values for a hidden layer based on the values of the neurons of the previous layer and associated array of weights, bias vector, and activation functions is repeated for all layers in the neural network. As stated above, the number of layers in a neural network is a hyperparameter of the neural network (700).

It is noted that FIG. 7 depicts a simple and general neural network (700). In some embodiments, the neural network (700) may contain specialized layers, such as a normalization layer, or additional connection procedures, like concatenation. One skilled in the art will appreciate that these alterations do not exceed the scope of this disclosure. For example, neural network (700) with only connections (720) passing signals forward from the input layer (702) to the first hidden layer (704), from the first hidden layer (704) to the second hidden layer (706) and so forth constitutes a feed-forward neural network. However, in some embodiments a neural network may have any number of connections, such as connection (740), that passes the output of a neuron (714) backward to the input of the same neuron (712), and/or any number of connections (742) that passes the output of the neuron (712) in a hidden layer, such as hidden layer (706) backward to the input of a neuron in a preceding hidden layer, such as hidden layer (704). A neural network with backward-passing connections, such as connection (740) and (742) may be termed a recurrent neural network.

For a neural network (700) to complete a “task” of predicting an output from an input, the neural network (700) must first be trained. Training may be defined as the process of determining the values of all the weights and biases for each weight array and bias vector encompassed by the neural network (700).

To begin training the weights and biases are assigned initial values. These values may be assigned randomly, assigned according to a prescribed distribution, assigned manually, or by some other assignment mechanism. Once the weights and biases have been initialized, the neural network (700) may act as a function, such that it may receive inputs and produce an output. As such, at least one input is propagated through the neural network (700) to produce an output. A training dataset is composed of inputs and associated target(s), where the target(s) represent the “ground truth”, or the otherwise desired output. That is, the training dataset may be a plurality of input data and a plurality of output data either of which are observed or simulated. The neural network (700) output is compared to the associated input data target(s). The comparison of the neural network (700) output to the target(s) is typically performed by a so-called “loss function”; although other names for this comparison function such as “error function”, “objective function”, “misfit function”, and “cost function” are commonly employed. Many types of loss functions are available, such as the mean-squared-error function, however, the general characteristic of a loss function is that the loss function provides a numerical evaluation of the similarity between the neural network (700) output and the associated target(s). The loss function may also be constructed to impose additional constraints on the values assumed by the weights and biases, for example, by adding a penalty term, which may be physics-based, or a regularization term. Generally, the goal of a training procedure is to alter the weights and biases to promote similarity between the neural network (700) output and associated target(s) over the training dataset. Thus, the loss function is used to guide changes made to the weights and biases, typically through a process called “backpropagation”.

While a full review of the backpropagation process exceeds the scope of this disclosure, a brief summary is provided. Backpropagation consists of computing the gradient of the loss function over the weights and biases. The gradient indicates the direction of change in the weights and biases that results in the greatest change to the loss function. Because the gradient is local to the current weights and biases, the weights and biases are typically updated by a “step” in the direction indicated by the gradient. The step size is often referred to as the “learning rate” and need not remain fixed during the training process. Additionally, the step size and direction may be informed by previously seen weights and biases or previously computed gradients. Such methods for determining the step direction are usually referred to as “momentum” based methods.

Once the weights and biases have been updated, or altered from their initial values, through a backpropagation step, the neural network (700) will likely produce different outputs. Thus, the procedure of propagating at least one input through the neural network (700), comparing the neural network (700) output with the associated target(s) with a loss function, computing the gradient of the loss function with respect to the weights and biases, and updating the weights and biases with a step guided by the gradient, is repeated until a termination criterion is reached. Common termination criteria are: reaching a fixed number of updates, otherwise known as an iteration counter; a diminishing learning rate; noting no appreciable change in the loss function between iterations; reaching a specified performance metric as evaluated on the data or a separate hold-out dataset. Once the termination criterion is satisfied, and the weights and biases are no longer intended to be altered, the neural network (700) is said to be “trained”.

Following training, the neural network (700) may perform a task to predict unknown output data from input data. If additional input data and corresponding output data become available that augment the training dataset, the neural network (700) may be re-trained. Re-training may encompass re-initializing the weights and biases and repeating the backpropagation process using the augmented training dataset. Alternatively, re-training may use a transfer learning approach where a subset of the weights and biases are fixed, and the remaining weights and biases are updated using the augmented training dataset.

In accordance with one or more embodiments, the ML network may be a recurrent neural network. the basic element of a recurrent neural network (RNN) is the recurrent neuron, which features a passage that relays the current neuron output to the neuron input in the next sample in the data series. Thus, by implementing the RNN, the current system state can be modeled as a function of the current sensor measurements and the preceding system state. In practice, the sensor measurements ( . . . xₙ₋₁, xₙ, xₙ₊₁, . . . ) that are simultaneously supplied into the network are transformed into a series of predicted systems states ( . . . yₙ₋₁, yₙ, yₙ₊₁, . . . ) at the network output through two sets of weights: wₓ, w_{y}, a bias term b and an activation function φ(.):

yₙ=φ(wₓ^{T}xₙ+w_{y}yₙ₋₁+b) Equation (6).

The network training may begin by initializing the weights and system state prediction. The prediction error, or cost function may be obtained by comparing the predicted values with the desired ones that may be obtained from a training dataset. Next, the individual weights may be updated using corresponding gradients of the cost function calculated from the predicted values and the desired values. In some embodiments, the cost function may be a least squares difference cost function. The update rate may be controlled by learning rate. The training process may terminate when the prediction error (the difference between the predicted values and the desired values) decreases below a pre-defined threshold or a pre-determined number of iterations has been completed.

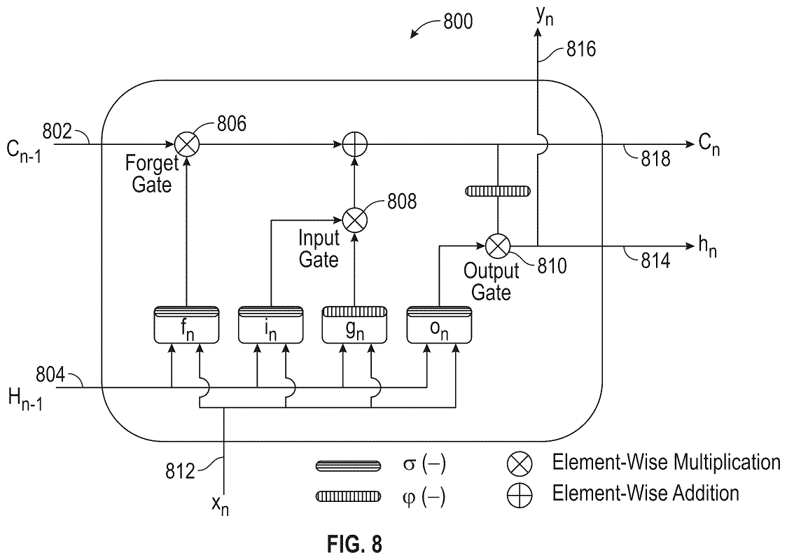

Standard RNN may not retain relevant patterns from the early samples through the network structure, as the standard RNN do not have a structure to retain the long-term memory. In accordance with one or more embodiments, to solve this problem a Long Short-Term Memory (“LSTM”) network may use a family of recurrent cells. The LSTM cell (800) features two distinct components, as shown in FIG. 8. First, a long-term state cₙ₋₁ input (802), in addition to the short-term state hₙ₋₁ input (804). Second, three control gates may be added to regulate the data flow: the forget gate (806), input gate (808) and an output gate (810). The forget gate fₙ (806) may be formed from the current input xₙ (812) and the previous short-term state hₙ₋₁ (804). The forget gate (806) may be expressed mathematical as:

fₙ=σ(wₓ^{T}xₙ+w_{y}yₙ₋₁+b) Equation (7),
where σ is the sigmoid function.

The information addition to the input long-term state cₙ₋₁ (802) may be determined by the signal to the input gate iₙ (808). The output gate oₙ (810) may govern the formation of the outgoing short-term state hₙ (814). Computations at input (808) and output gate (810) may be analogous to the forget gate (806). It should be noted that the input gₙ may be a layer comprised of standard recurrent neurons. Thus, in contrast to the standard recurrent neuron, in LSTM networks (800), only a portion of the output (816) may be transferred to the current state and the path associated with the long-term state may not go through the full operation as in Equation (7). Finally, the LSTM cell (800) output (816), short-term state (814) and long-term state (818) are computed through element-wise multiplication, ⊗. Specifically, the forget gate (806) may first regulate the incoming long-term state cₙ₋₁ (802) from the previous sample, then additional information is added through the input gate iₙ (808) to form the outgoing current long-term state cₙ (818). The current output yₙ (816) is the same as the outgoing current short-term state hₙ (814), which is obtained through regulating long-term state (818) using output gate oₙ (810). The expressions for cₙ and yₙ are:

cₙ=fₙ⊗cₙ₋₁+iₙ⊗gₙ, Equation (8); and

yₙ=hₙ=oₙ⊗φ(cₙ) Equation (9).

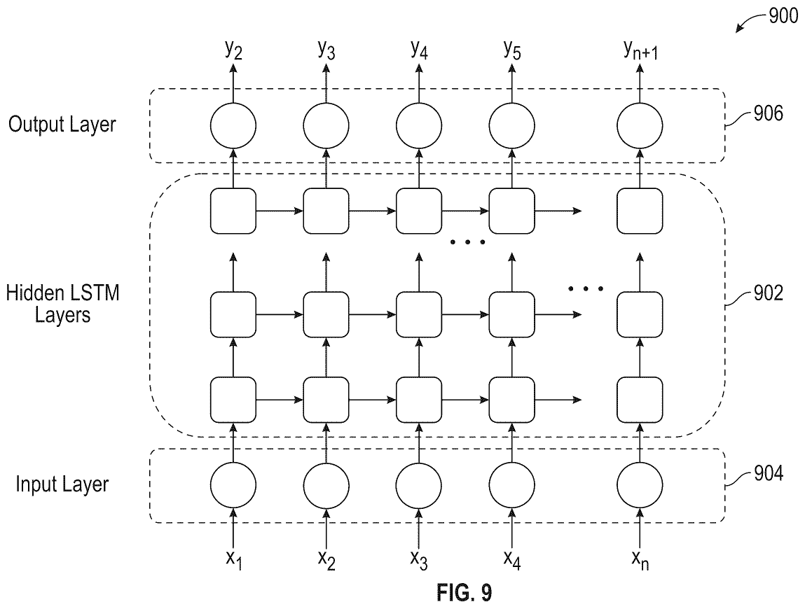

In accordance with some embodiments, an LSTM network may have a single layer of LSTM cells between the input layer and the output layer. In other embodiments, as shown in FIG. 9, a LSTM network may be composed of multiple hidden layers (902) of LSTM cells (800) between the input layer (904) and the output layer (906), and as input data passes through the neural network structure (900), the output generated in each layer may be regarded as the input data for the next layers. Thus, adding additional layer may improve the probability of discovering the connections between the inputs and outputs and better prediction of the desired outputs. Such an LSTM network (900) with multiple hidden layers (902) may be called a “deep LSTM network”.

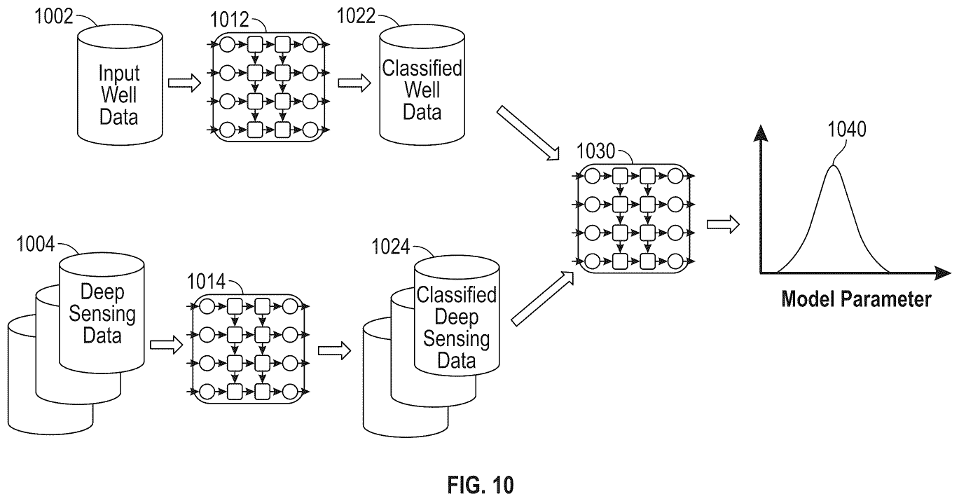

FIG. 10 depicts system components in accordance with one or more embodiments. The input data may include input well data (1002) such as well logs from at least one well (106, 110) penetrating a hydrocarbon reservoir (100). The input well data (1002) may include well log data recorded using a wireline deployed tool, well log data recorded while drilling (“LWD” data, and/or core data determined from core samples taken while drilling from the wellbore, or later from sidewall core samples recovered from the wall of the wellbore.

In addition, in according to some embodiments, the input data may include input EM data (1004) recorded above the reservoir using surface EM surveys that may be marine, terrestrial, or aerial recording and may be either passive or active-source EM surveys. Further, the EM data (1004) may be crosswell EM data recorded with an active EM source in one wellbore and at least one receiver in another wellbore, where both penetrate the subterranean region of interest.

In accordance with some embodiments, the input data may include input seismic data (1006) recorded above the reservoir using surface seismic surveys that may be marine, or terrestrial (land) recording and may be either passive or active-source seismic surveys. Further, the seismic data (1006) may be crosswell seismic data recorded with an active seismic source in one wellbore and at least one receiver in another wellbore, where both wellbores penetrate the subterranean region of interest (202).

Each input dataset may form the input of a ML network in accordance with one or more embodiments. For example, the well data may form the input to a first ML network (1012) configured to classify the input well data (1002) and output classified well data (1022). The classification performed by the first ML network (1012) may include identifying and excluding outlier samples from the classified well data. The identification of outlier samples may be based upon determining a best-fit multi-variate probability distribution for the well data samples and excluding samples lying outside the probable range of the multi-variate probability distribution. Further the classification performed by the first ML network (1012) may include identifying the uncertainty of the well log data based upon the parameters of the best-fit multi-variate probability distribution function. The input features encompass saturation profiles, porosity, well production rates, choke size, various well logs, such as gamma ray log, amongst others. Similarly, in accordance with one or more embodiments, the input deep sensing data (1004) may form the input to a second ML network (1014) configured to classify the input deep sensing data (1004) and output classified deep sensing data (1024). As for the first ML network (1012), the classification performed by the second ML network may include fitting a best-fit multi-variate probability distribution, excluding outlier data samples, and determining one or more uncertainties of the classified deep sensing data (1024). The input information from the first ML network may be integrated into the second ML network, in addition to the classification results from the first ML network. For each of the input features, their uncertainty ranges are to be indicated.

In accordance with one or more embodiments, the deep sensing data may be EM data or seismic data, or gravity data, alone or in combination. Further the deep sensing data may be time-lapse deep sensing data including multiple EM, seismic or gravity surveys recorded at times separated by weeks, months or years during which fluid injection and hydrocarbon production form the hydrocarbon reservoir has taken place.

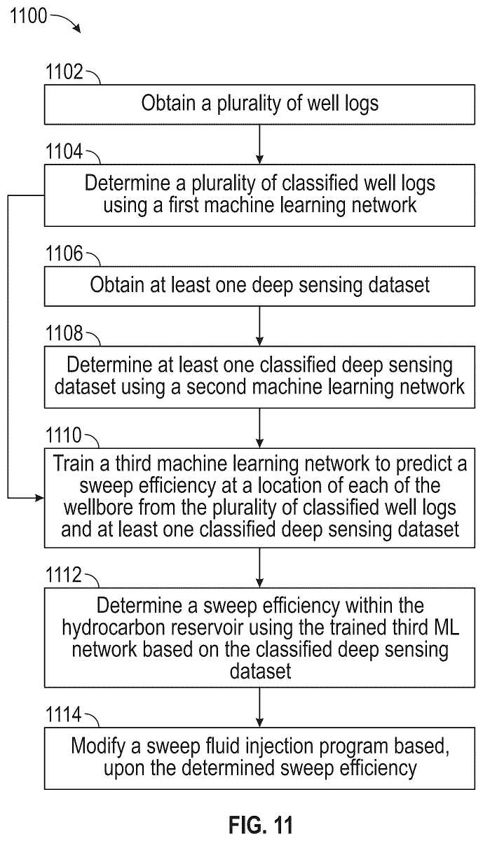

FIG. 11 shows a flowchart in accordance with one or more embodiments. In Step 1102 a well log for each of a plurality of wellbores penetrating the hydrocarbon reservoir may be obtained. The well log may include measured values of one or more physical parameters of the formation penetrated by the wellbore, recorded at a plurality of depths. For example, the physical parameter may be, without limitation, resistivity, gamma ray emission, density, acoustic velocity, nuclear magnetic resonance, and spontaneous potential.

In Step 1104 a plurality of classified well logs may be determined, one from each well log obtained in Step 1102, using a first ML (ML) network. The classification may include identifying unreliable well log samples, determining a validated well log by eliminating the unreliable well log samples from the well log, and estimating an uncertainty log based, at least in part, on the validated well log. The estimated uncertainty may be in the form of a multi-variate probability distribution for a plurality of physical parameters.

In Step 1106, a deep sensing dataset for the hydrocarbon reservoir may be obtained. In some embodiments, the deep sensing dataset may be an EM dataset. In other embodiments, the deep sensing dataset may be a seismic dataset. In yet other embodiments, the deep sensing dataset may be a gravity dataset. Further the deep sensing datasets may be time-lapse datasets including measurements acquired at intervals separated weeks, months or years during which production from and injection into the hydrocarbon reservoir may have occurred. In still other embodiments the deep sensing datasets may include combinations of two or more measurement types including EM, seismic, and gravity measurements.

In Step 1108, one or more classified deep sensing datasets may be determined, from the one or more deep sensing datasets obtained in Step 1102, using a second ML network. The classification may include identifying unreliable deep sensing samples, determining a validated deep sensing dataset by eliminating the unreliable deep sensing samples from the deep sensing dataset, and estimating an uncertainty based, at least in part, on the validated deep sensing dataset. The estimated uncertainty may be in the form of a multi-variate probability distribution for a plurality of physical parameters.

In accordance with some embodiments, one or both of the first and second ML network may be unsupervised ML networks. For example, the unsupervised ML networks may be K-mean clustering networks.

In Step 1110, in accordance with one or more embodiments, a third ML network may be trained to predict the sweep efficiency at a location of each of the wellbore based, at least in part on the plurality of classified well logs and the at least one classified deep sensing dataset. Predicting the sweep efficiency may include predicting a value of the swept pore volume at each location and, in addition, determining an uncertainty in the sweep efficiency prediction. The third ML network may integrate the input features from the second ML network in addition to its outputs.

In Step 1112, sweep efficiency within the hydrocarbon reservoir may be determined using the trained third ML network based, at least in part, on the classified deep sensing dataset. The sweep efficiency may be determined at a plurality of locations within the hydrocarbon reservoir, including locations not penetrated by a wellbore. Further, the trained third ML network may be used to determine sweep efficiencies at a plurality of points throughout the reservoir at a later time from deep sensing data acquired at that later time.

In Step 1114, in accordance with one or more embodiments, the sweep fluid injection program may be modified based, at least in part, upon the determined sweep efficiency. For example, the rate of fluid injection may be increased in some fluid injection wells, such as fluid injection well (112) while reducing the rate of fluid injection at other injection wells. Alternatively, production from some production wells (108) may be temporarily or permanently ceased or additionally converted into injection wells (112).

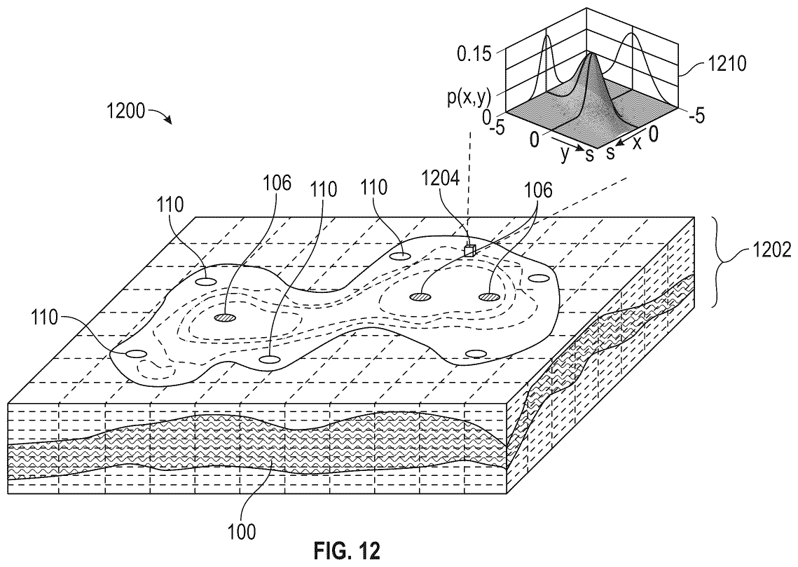

FIG. 12 depicts a further practical application of the determined sweep efficiency values including the uncertainty in the determined sweep efficiency values. FIG. 12 shows a reservoir simulation model (1200) that may be used to predict fluid movement within the hydrocarbon reservoir (100). The hydrocarbon reservoir (100) may include various production wells (106). Likewise, a reservoir region may also include one or more injection wells (110) that include functionality for enhancing the hydrocarbon production of one or more neighboring production wells (106).

The reservoir simulator may use a reservoir simulation model (1200) that contains a digital description of the physical properties of the rocks as a function of position within the hydrocarbon reservoir (100) and the fluids within the pores of the porous, permeable reservoir rocks at a given time. In some embodiments, the digital description may be in the form of a dense 3D grid (1202) with the physical properties of the rocks and fluids defined at each node or voxel (1204). In some embodiments, the 3D grid (1202) may be a cartesian grid, while in other embodiments the grid may be an irregular grid.

The physical properties of the rocks and fluids within the hydrocarbon reservoir (100) may be obtained from a variety of geological and geophysical sources. For example, deep sensing surveys, such as seismic surveys, gravity surveys, and active and passive source EM surveys, may be employed. In addition, data collected such as well logs, core data, production data as previously discussed, acquired in wells penetrating the hydrocarbon reservoir (100) may be used to determine physical and petrophysical properties along the segment of the well trajectory traversing the hydrocarbon reservoir (100). For example, porosity, permeability, density, seismic velocity, and resistivity may be measured along these segments of wellbore. In accordance with some embodiments, deep sensing surveys and physical and petrophysical properties determined from well logs may be combined to estimate physical and petrophysical properties for the entire reservoir simulation model grid.

In some embodiments, a reservoir simulator may include functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator may be used to predict changes in fluid flow, including fluid flow into well penetrating the reservoir as a result of planned well drilling, fluid production and in particular fluid injection. For example, the reservoir simulator may be used to predict changes in hydrocarbon production rate and the total ultimate production that would result from the injection of water into the hydrocarbon reservoir from injection wells (110) around the reservoirs periphery.

Reservoir simulators solve a set of mathematical governing equations that represent the physical laws that govern fluid flow in porous, permeable media. For example, the flow of a single-phase slightly compressible oil with a constant viscosity and compressibility the equations capture Darcy's law, the continuity condition and the equation of state and may be written as:

$${∇}^{2} p ( x , t ) = \frac{φμ {c}_{t}}{k} \frac{\partial p ( x , t )}{\partial t} , \qquad Equation ( 10 )$$

where p represents fluid in the reservoir, x is a vector representing spatial position and t represents time. φ, μ, cₜ, and k represent the physical and petrophysical properties of porosity, fluid viscosity, total combined rock and fluid compressibility, and permeability, respectively. ∇² represents the spatial Laplacian operator.

Additional, and more complicated equations, such as the Peng-Robinson EoS may be required when more than one fluid, or more than one phase, e.g., liquid and gas, are present in the reservoir. Further, when the physical and petrophysical properties of the rocks and fluids vary as a function of position the governing equations may not be solved analytically and must instead be discretized into a grid of cells or blocks. The governing equations must then be solved by one of a variety of numerical methods, such as, without limitation, explicit or implicit finite-difference methods, explicit or implicit finite element methods, or discrete Galerkin methods.

However, in the absence of methods of monitoring fluid motion, such as estimation of sweep efficiency, quantitative predictions of future production rates and cumulative rates in response to various injection scenarios have proved problematic and prone to error. Typically, the parameters such as porosity and permeability of the full hydrocarbon reservoir volume are not known with sufficient accuracy to make a confident and accurate future prediction. However, when values of simulation model porosity and permeability may be adjusted, either by manual trial and error or using formal inversion methods, so that predicted injection fronts and sweep efficiency match the determined sweep efficiency to within the determined uncertainty, then prediction of future fluid motions and hydrocarbon production in response to fluid injection scenarios may be made with much greater confidence. The workflow described in FIG. 11 provides a method for estimating the sweep efficiency and the uncertainty in the sweep efficiency (1210) at each grid point or voxel (1204) that may be compared with the values predicted by the reservoir simulator. Further the comparison facilitates updating the parameters, such as the porosity and permeability, of the reservoir simulator model to provide an improved prediction of fluid motion under future fluid injection scenarios.

In accordance with one or more embodiments, the first, second, and third ML networks may be implemented on a computer system such as the computer system depicted in FIG. 13. FIG. 13 further depicts a block diagram of a computer system (1302) used to provide computational functionalities associated with described algorithms, methods, functions, processes, flows, and procedures as described in this disclosure, according to one or more embodiments. In particular, FIG. 13 may depict a ML engine for performing the method for determining an updated geophysical model (790) for a subterranean region of interest (202).

The illustrated computer (1302) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1302) may include an input device, such as a keypad, keyboard, touch screen, or other device that can accept user information, and an output device that conveys information associated with the operation of the computer (1302), including digital data, visual, or audio information (or a combination of information), or a GUI.

The computer (1302) can serve in a role as a client, network component, a server, a database or other persistency, or any other component (or a combination of roles) of a computer system for performing the subject matter described in the instant disclosure. The illustrated computer (1302) is communicably coupled with a network (1330). In some implementations, one or more components of the computer (1302) may be configured to operate within environments, including cloud-computing-based, local, global, or other environment (or a combination of environments).

At a high level, the computer (1302) is an electronic computing device operable to receive, transmit, process, store, or manage data and information associated with the described subject matter. According to some implementations, the computer (1302) may also include or be communicably coupled with an application server, e-mail server, web server, caching server, streaming data server, business intelligence (BI) server, or other server (or a combination of servers).

The computer (1302) can receive requests over network (1330) from a client application (for example, executing on another computer (1302) and responding to the received requests by processing the said requests in an appropriate software application. In addition, requests may also be sent to the computer (1302) from internal users (for example, from a command console or by other appropriate access method), external or third-parties, other automated applications, as well as any other appropriate entities, individuals, systems, or computers.

Each of the components of the computer (1302) can communicate using a system bus (1303). In some implementations, any or all of the components of the computer (1302), both hardware or software (or a combination of hardware and software), may interface with each other or the interface (1304) (or a combination of both) over the system bus (1303) using an application programming interface (API) (1312) or a service layer (1313) (or a combination of the API (1312) and service layer (1313). The API (1312) may include specifications for routines, data structures, and object classes. The API (1312) may be either computer-language independent or dependent and refer to a complete interface, a single function, or even a set of APIs. The service layer (1313) provides software services to the computer (1302) or other components (whether or not illustrated) that are communicably coupled to the computer (1302). The functionality of the computer (1302) may be accessible for all service consumers using this service layer. Software services, such as those provided by the service layer (1313), provide reusable, defined business functionalities through a defined interface. For example, the interface may be software written in JAVA, C++, or other suitable language providing data in extensible markup language (XML) format or another suitable format. While illustrated as an integrated component of the computer (1302), alternative implementations may illustrate the API (1312) or the service layer (1313) as stand-alone components in relation to other components of the computer (1302) or other components (whether or not illustrated) that are communicably coupled to the computer (1302). Moreover, any or all parts of the API (1312) or the service layer (1313) may be implemented as child or sub-modules of another software module, enterprise application, or hardware module without departing from the scope of this disclosure.

The computer (1302) includes an interface (1304). Although illustrated as a single interface (1304) in FIG. 13, two or more interfaces (1304) may be used according to particular needs, desires, or particular implementations of the computer (1302). The interface (1304) is used by the computer (1302) for communicating with other systems in a distributed environment that are connected to the network (1330). Generally, the interface (1304) includes logic encoded in software or hardware (or a combination of software and hardware) and operable to communicate with the network (1330). More specifically, the interface (1304) may include software supporting one or more communication protocols associated with communications such that the network (1330) or interface's hardware is operable to communicate physical signals within and outside of the illustrated computer (1302).

The computer (1302) includes at least one computer processor (1305). Although illustrated as a single computer processor (1305) in FIG. 13, two or more processors may be used according to particular needs, desires, or particular implementations of the computer (1302). Generally, the computer processor (1305) executes instructions and manipulates data to perform the operations of the computer (1302) and any algorithms, methods, functions, processes, flows, and procedures as described in the instant disclosure.

The computer (1302) also includes a memory (1306) that holds data for the computer (1302) or other components (or a combination of both) that can be connected to the network (1330). For example, memory (1306) may be a non-transitory computer readable medium memory (1306) can be a database storing data consistent with this disclosure. Although illustrated as a single memory (1306) in FIG. 13, two or more memories (1306) may be used according to particular needs, desires, or particular implementations of the computer (1302) and the described functionality. While memory (1306) is illustrated as an integral component of the computer (1302), in alternative implementations, memory (1306) can be external to the computer (1302).

The application (1307) is an algorithmic software engine providing functionality according to particular needs, desires, or particular implementations of the computer (1302), particularly with respect to functionality described in this disclosure. For example, application (1307) can serve as one or more components, modules, applications, etc. Further, although illustrated as a single application (1307), the application (1307) may be implemented as multiple applications (1307) on the computer (1302). In addition, although illustrated as integral to the computer (1302), in alternative implementations, the application (1307) can be external to the computer (1302).

There may be any number of computers (1302) associated with, or external to, a computer system containing a computer (1302), wherein each computer (1302) communicates over network (1330). Further, the term “client,” “user,” and other appropriate terminology may be used interchangeably as appropriate without departing from the scope of this disclosure. Moreover, this disclosure contemplates that many users may use one computer (1302), or that one user may use multiple computers (1302).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A method for determining a sweep efficiency within a hydrocarbon reservoir, comprising:
obtaining a well log for each of a plurality of wellbores penetrating the hydrocarbon reservoir;
obtaining a deep sensing dataset for the hydrocarbon reservoir;
determining a plurality of classified well logs, one from each well log using a first machine learning (ML) network;
determining a classified deep sensing dataset from the deep sensing dataset using a second ML network;
training a third ML network to predict the sweep efficiency based, at least in part on the plurality of classified well logs and the classified deep sensing dataset at a location of each of the wellbores; and
determining the sweep efficiency within the hydrocarbon reservoir using the trained third machine learning network based, at least in part, on the classified deep sensing dataset.

2. The method of claim 1, further comprising modifying a sweep fluid injection program based, at least in part, upon the determined sweep efficiency.

3. The method of claim 1, wherein the deep sensing dataset is a deep electromagnetic dataset.

4. The method of claim 1, wherein training the third ML network to predict the sweep efficiency further comprises training the third ML network to predict an uncertainty in the sweep efficiency prediction.

5. The method of claim 1, wherein the sweep efficiency comprises a multi-variate probability distribution for a plurality of subsurface parameters.

6. The method of claim 1, wherein determining each of the plurality of classified well logs comprises:
identifying unreliable well log samples;
determining a validated well log by eliminating the unreliable well log samples from the well log; and
estimating an uncertainty log based, at least in part, on the validated well log.

7. The method of claim 1, wherein determining the classified deep sensing dataset comprises:
identifying unreliable deep sensing dataset samples;
determining a validated deep sensing dataset log by eliminating the unreliable deep sensing dataset samples from the deep sensing dataset; and
estimating an uncertainty deep sensing dataset, at least in part, on the validated deep sensing dataset.

8. The method of claim 1, wherein the first ML network and the second ML network are unsupervised ML networks.

9. A non-transitory computer readable medium storing instructions executable by a computer processor, the instructions comprising functionality for:
receiving a well log for each of a plurality of wellbores penetrating a hydrocarbon reservoir;
receiving a deep sensing dataset for the hydrocarbon reservoir;
determining a plurality of classified well logs, one from each well log using a first machine learning (ML) network;
determining a classified deep sensing dataset from the deep sensing dataset using a second ML network;
training a third ML network to predict a sweep efficiency based, at least in part on the plurality of classified well logs and the classified deep sensing dataset at a location of each of the wellbores; and
determining a sweep efficiency within the hydrocarbon reservoir using the trained third machine learning network based, at least in part, on the classified deep sensing dataset.

10. The non-transitory computer readable medium of claim 9, wherein the deep sensing dataset is a deep electromagnetic dataset.

11. The non-transitory computer readable medium of claim 9, wherein training the third ML network to predict the sweep efficiency further comprises training the third ML network to predict an uncertainty in the sweep efficiency prediction.

12. The non-transitory computer readable medium of claim 9, wherein the sweep efficiency a multi-variate probability distribution for a plurality of subsurface parameters.

13. The non-transitory computer readable medium of claim 9, wherein determining each of the plurality of classified well logs comprises:
identifying unreliable well log samples;
determining a validated well log by eliminating the unreliable well log samples from the well log; and
estimating an uncertainty log based, at least in part, on the validated well log.

14. The non-transitory computer readable medium of claim 9, wherein determining the classified deep sensing dataset comprises:
identifying unreliable deep sensing dataset samples;
determining a validated deep sensing dataset log by eliminating the unreliable deep sensing dataset samples from the deep sensing dataset; and
estimating an uncertainty deep sensing dataset, at least in part, on the validated deep sensing dataset.

15. The non-transitory computer readable medium of claim 9, wherein the first ML network and the second ML network are unsupervised ML networks.

16. A system, comprising:
a computer system configured to:
receive a well log for each of a plurality of wellbores penetrating a hydrocarbon reservoir;
receive a deep sensing dataset for the hydrocarbon reservoir;
determine a plurality of classified well logs, one from each well log using a first machine learning (ML) network;
determine a classified deep sensing dataset from the deep sensing dataset using a second ML network;
train a third ML network to predict a sweep efficiency based, at least in part on the plurality of classified well logs and the classified deep sensing dataset at a location of each of the wellbores;
determine a sweep efficiency within the hydrocarbon reservoir using the trained third machine learning network based, at least in part, on the classified deep sensing dataset; and
modify a sweep fluid injection program based, at least in part, upon the determined sweep efficiency; and
a fluid injection system configured to pump the modified sweep fluid injection program.

17. The system of claim 16, wherein the fluid injection system comprises:
a source of injection fluid;
at least one injection fluid pump connected to the source of injection fluid; and
a plurality of injection wellbore penetrating the hydrocarbon reservoir and connected to injection fluid pump.

18. The system of claim 16, wherein the deep sensing dataset is a deep electromagnetic dataset.

19. The system of claim 16, wherein training the third ML network to predict the sweep efficiency further comprises training the third ML network to predict an uncertainty in the sweep efficiency prediction.

20. The system of claim 16, wherein training the third ML network to predict the sweep efficiency further comprises training the third ML network to predict an uncertainty in the sweep efficiency prediction.
